(19) United States
(12) Patent Application Publication
(10) Pub. No.: US 2008/0276006 A1
(43) Pub. Date: Nov. 6, 2008

(54) Systems and Methods for Providing Terminal Configuration Data

(75) Inventor: Felix Choi, Brossard (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/743,521

(22) Filed: May 2, 2007

(51) Int. Cl. G06F 15/16

(52) U.S. Cl. 709/245

(57) ABSTRACT

Communication nodes, systems and methods are described which provide mechanisms and techniques for providing terminal configuration data from, e.g., a CNG Configuration Function (CNGCF), to, e.g., a configuration function (CNG) in a user's equipment. The information needed by the CNGCF to provide this terminal configuration data file, e.g., an IP address of the user equipment, a service subscription identification associated with the user equipment and a terminal type, are provided via an interface between a Connectivity Session Location and Repository Function (CLF) and the CNGCF.

### TECHNICAL FIELD

The present invention generally relates to communication systems and methods and, more particularly, to mechanisms and techniques for providing terminal configuration data.

### BACKGROUND

Communication systems continue to grow and evolve. Convergence between different types of communication systems, e.g., Internet Protocol (IP), connection-based voice communications, and the like, is advancing rapidly. Recently the phrase “Next Generation Network” (NGN) has been used to describe various activities associated with this evolution. As defined by the International Telecommunications Union (ITU), an NGN is a packet-based network able to provide services (including telecommunication services), able to make use of multiple broadband, QoS-enabled transport technologies and in which service-related functions are independent from underlying transport-related technologies. NGNs will also likely offer unrestricted access by users to different service providers and will support generalized mobility, which in turn will provide for consistent service provision to end users.

Various standardization groups are working on reaching a consensus regarding the technology considerations which will affect NGN design and implementation. For example, Telecoms & Internet converged Services & Protocols for Advanced Networks (TISPAN) is an ETSI standardization group which focuses on convergence of technologies used in the Internet and other fixed networks. Among other things, TISPAN seeks to provide a modular, subsystem-oriented architecture which facilitates the addition of new subsystems over time to cover new demands and service classes. The TISPAN architecture attempts to ensure that network resources, applications, and user equipment are common to all of the various subsystems to provide for enhanced mobility across, for example, administrative boundaries.

One of the TISPAN subsystems is referred to as the Network Attachment Sub System (NASS). The NASS is responsible for, among other things, handling configuration information, user authentication data, IP address allocation and registering associations between IP addresses allocated to user equipment (UE) and related network location information. An exemplary NASS architecture is illustrated in FIG. 1, which corresponds to FIG. 5.1 in the ETSI standards document entitled “Telecommunications and Internet converged Services and Protocols for Advanced Networking (TISPAN); NGN Functional Architecture; Network Attachment Sub-System (NASS)”, ETSI ES 282 004V1.1.1 (2006-06). A brief discussion regarding the functional entities shown in FIG. 1 is provided below, however the reader interested in more details is directed to the foregoing standards document. Additionally, in FIG. 1, the links between the various entities represent interfaces. Those interfaces which have a lowercase letter and number combination associated therewith (e.g., “e2” and “a3”) refer to standardized interfaces discussed in the foregoing standards document.

For example, the Connectivity Session Location and Repository Function (CLF) 10 operates to, among other things, register the association between the IP address allocated to the user equipment (UE) 12 for a connection and related network location information provided by the Network Access Configuration Function (NACF) 14, such as access transport equipment characteristics, line identifier (Logical Access ID), IP Edge identity, etc. The NACF 14 thus operates to allocate IP address(es) to the UE 12 and may also provide other network configuration parameters, such as the address of DNS server(s) and the address of signaling proxies for specific protocols. The CLF 10 is also in communication with the Resource and Admission Control Subsystem (RACS) 16, other service control subsystems and applications 18, and the User Access Authorization Function (UAAF) 20. The UAAF 20 performs user authentication and authorization checking based on user profiles for network access. The UAAF 20 retrieves authentication data and access authorization information from user network profile information contained in the Profile Database Function (PDBF) 22.

The Access Management Function (AMF) 24 translates network access requests issued by the UE 12 and forwards those requests for allocation of an IP address and, optionally, additional network configuration parameters to/from the NACF 14. The AMF 24 also forwards requests to the UAAF 20 to authenticate the user, authorize or deny network access, and retrieve user-specific access configuration parameters. The NASS architecture further for an Access Relay Function (ARF) 26 as a relay between the Customer Network Gateway (CNG) 28 and the NASS which inserts local configuration information.

As shown in FIG. 1, the UE 12 can be functionally divided into the terminal equipment (TE) 30 itself and the CNG 28. Of particular interest for the present application, the CNG 28 receives configuration data from the CNG Configuration Function (CNGCF) 32. More specifically, as stated in the above-identified standards document, the CNGCF 32 is used during initialization and update of the CNG 28 to provide the CNG 28 with additional configuration information (e.g. configuration of a firewall internally in the CNG 28, QoS marking of IP packets etc.), which configuration data differs from the network configuration data provided by the NACF 14.

However, no mechanism or technique is described in this standards document relating to how the CNGCF 32 is to provide such information to the CNG 28 of the UE 12. Accordingly, it would be desirable to provide such mechanisms and techniques.

### SUMMARY

According to an exemplary embodiment, a network node includes a processor for receiving information associated with an address of a user equipment, a service subscription identifier associated with the user equipment and a terminal type associated with the user equipment, and a memory for storing configuration data files indexed by service subscription identifier and terminal type, wherein the processor uses the received service subscription identifier and terminal type to retrieve a corresponding configuration data file from the memory and forwards the configuration data file to the address.

According to another exemplary embodiment, a method for providing configuration data associated with user equipment to a configuration function includes the steps of storing configuration data files indexed by service subscription identifier and terminal type, receiving information associated with an address of the user equipment, a service subscription identifier associated with the user equipment and a terminal type associated with the user equipment, retrieving, based on the received the service subscription identifier and terminal type, a corresponding configuration data file, and forwarding the configuration data file to the address.

According to yet another exemplary embodiment, a network node includes a processor for receiving, during network attachment of a user equipment, a service subscription identifier, an address of the user equipment associated with the service subscription identifier and a terminal type associated with the user equipment, and wherein the processor forwards the service subscription identifier, the address and the terminal type toward a Customer Network Gateway Configuration Function (CNGCF).

According to still another exemplary embodiment, a method for providing configuration data selection information to a configuration data file repository includes receiving a service subscription identification, an address of a user equipment associated with the service subscription identification, and a terminal type associated with the user equipment, and forwarding the service subscription identification, the address and the terminal type as the configuration data selection information.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a communication system arranged using a conventional Network Attachment Sub-System (NASS) architecture;

FIG. 2 illustrates a communication system arranged using a modified Network Attachment Sub-System (NASS) architecture according to an exemplary embodiment;

FIG. 3 depicts configuration data files stored in a memory of a CNG Configuration Function (CNGCF) according to an exemplary embodiment;

FIG. 4 is a signaling diagram showing an information flow between nodes in a communication network according to an exemplary embodiment;

FIG. 5 depicts IP addresses stored in a memory of a CNGCF indexed by service subscription ID according to an exemplary embodiment;

FIG. 6 illustrates a server according to an exemplary embodiment;

FIG. 7 is a flowchart depicting a method for providing configuration data associated with user equipment to a configuration function according to an exemplary embodiment; and

FIG. 8 is a flowchart depicting a method for providing configuration data selection information to a configuration data file repository according to an exemplary embodiment.

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

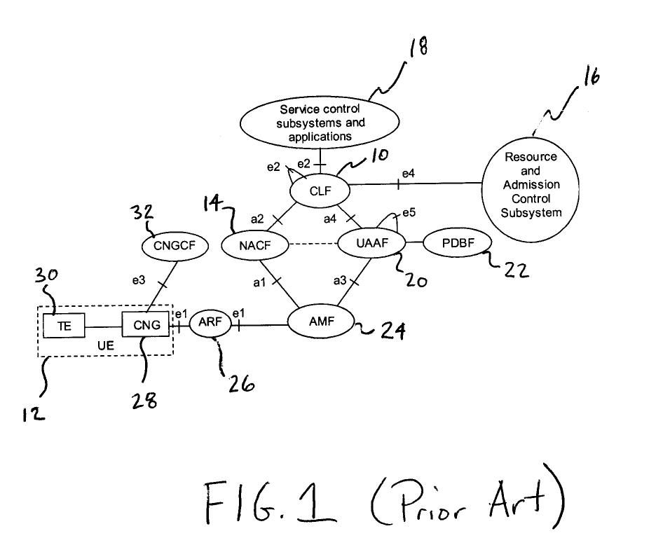

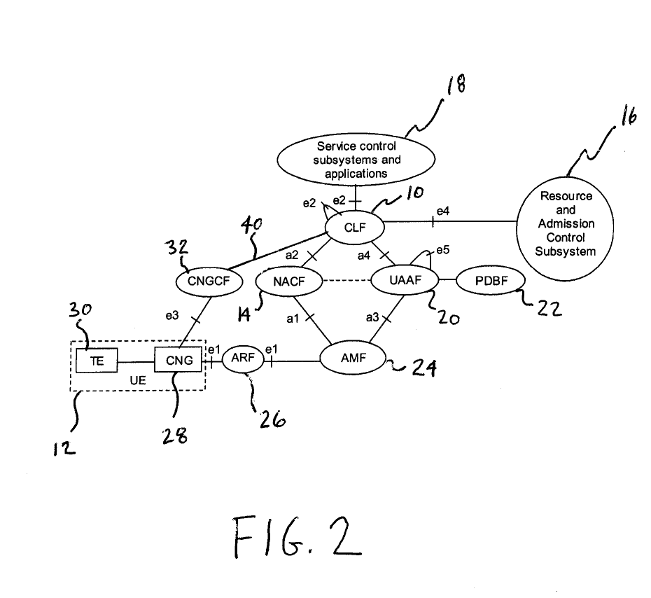

As mentioned above, it is desirable to provide systems and methods which enable the CNGCF 32 to provide configuration data to the CNG 28 (or, more generally, to the UE 12). Initially, these exemplary embodiments provide for, as shown in FIG. 2, an interface 40 between the CLF 10 and the CNGCF 32. Other than the CLF 10, CNGCF 32 and interface 40, the other components illustrated in FIG. 2 operate in the same manner as described above with respect to FIG. 1. At a high level, these exemplary embodiments provide the CNGCF 32 with, among other things, the capabilities to (1) locate a UE 12 whose CNG 28 needs configuration data (e.g., in response to initialization of the UE 12 or an system-determined need for updating) and (2) locate the correct configuration data file for the service which has been requested by the UE 12.

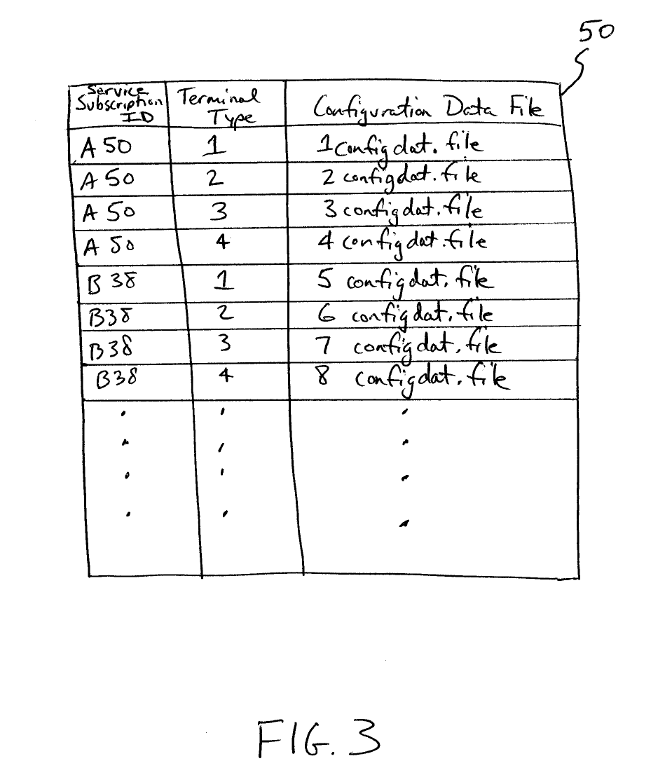

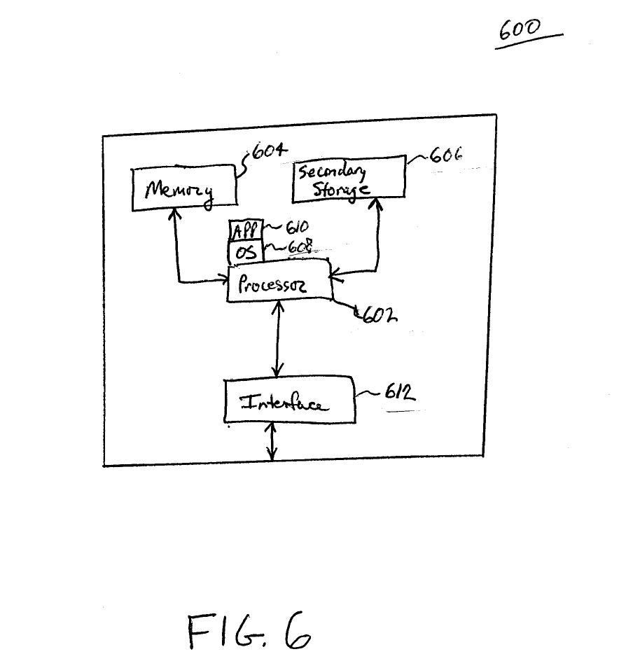

More specifically, the CNGCF 32, which can be implemented as a server as is described in more detail below with respect to FIG. 6, can receive (e.g., via interface 40 from CLF 10) information associated with an address of a user equipment to which a configuration data file is to be sent, a service subscription identifier (ID) associated with that user equipment and a terminal type associated with that user equipment. This information can then be used by the CNGCF 32 to retrieve an appropriate configuration data file to forward to the UE 12's CNG 28. For example, the CNGCF 32 can have a memory unit (not shown in FIG. 2) which stores a number of different configuration data files as shown in FIG. 3. In this exemplary embodiment, the configuration data files are indexed in memory unit 50 by a service subscription ID and by terminal type. Thus, when the CNGCF 32 receives a bundle of configuration data file selection information from the CLF 10 via interface 40, it can retrieve the corresponding configuration data file from its memory unit 50 and forward that file on to the UE 12/CNG 28. Forwarding of the retrieved configuration file is performed using the received address information, e.g., an Internet Protocol (IP) address.

During the fulfillment process, a subscriber will subscribe to new services. After the service subscription portal/system has approved the subscription, a service subscription ID is sent to the CLF 10 according to this exemplary embodiment. The service subscription ID can, for example, contain data representing the physical and virtual connection characteristics associated with this subscriber's service subscription. For example, the service subscription ID can contain a physical access line identifier which indicates the manner in which the network is physically connected to the subscriber's CNG 28, e.g., via a combination of a particular router, a particular network card and a particular port. Additionally, the service subscription ID can, for example, include a Virtual Port (VP) number and Virtual Circuit (VC) number to indicate a service flow, e.g., a Voice over IP (VOIP) service or an IPTV service, associated with the service subscription ID. Thus, more generally, the service subscription ID provides information about both a particular subscriber and a particular service to which that subscriber has subscribed. The service subscription ID can, according to these exemplary embodiments, be used as an index to a data record associated with the subscriber which contains other data (e.g. physical location, emergency points of contact, etc.) related to a subscriber's subscription, which record is stored in a memory unit of the CLF 10.

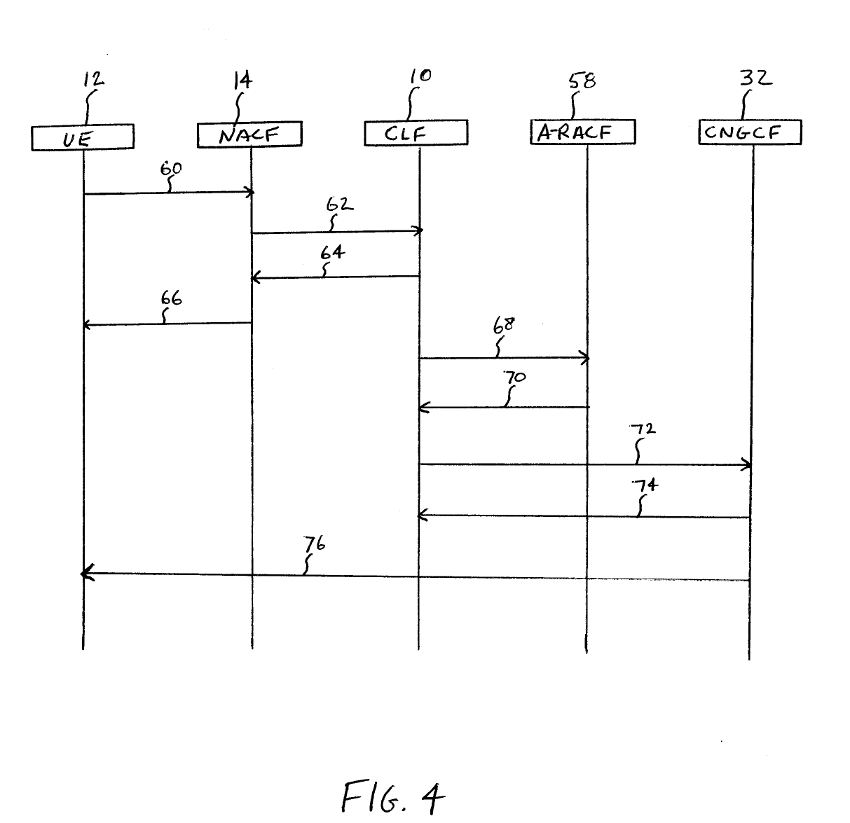

Later, when that user connects to the communication system during the network attachment process, the configuration data file can be provided to that use's UE 12/CNG 28 as shown in the signaling diagram of FIG. 4. Therein, the UE 12 initiates an access request by sending a signal 60 to NACF 14. Those skilled in the art will appreciate that other nodes will typically be disposed between the UE 12 and NACF 14, e.g., Digital Subscriber Line Access Multiplexer (DSLAM) and an Edge Router, which are not shown to simplify the figure. Additionally, signal 60 can represent a number of signals which are used to initiate the access process, e.g., Dynamic Host Configuration Protocol (DHCP) Discover and Offer signals if the NACF 14 is implemented as a DHCP server, and will also include information associated with the terminal type of the UE 12.

Regardless of the implementation details, the NACF 14 will assign, among other things, an IP address to the requesting UE 12/CNG 28 after receiving signal 60. This assigned IP address and the terminal type associated with UE 12/CNG 28, along with the corresponding service subscription ID among other things, will then be sent to the CLF 10 as signal 62. The CLF 10 acknowledges receipt (via signal 64) of the new IP access context signal 62 to the NACF 14, which in turn provides the UE 12/CNG 28 with its assigned IP address as well as any other information associated with the newly established connection, e.g., DHCP options, via signal 66. Using the service subscription ID as an index into its records, the CLF 10 can update the subscriber's record with the newly assigned IP address.

CLF 10 pushes the new IP context information to the A-RACF 58 via signal 68. Although not specifically shown in FIG. 2, the A-RACF 58 is an entity which is part of the RACS 16. The A-RACF 58, among other things, receives information about the IP address allocated to a particular user and maps that IP allocation to physical resources in the access network. With such input the A-RACF 58 can provide information to the CLF 10 that the required network resources (e.g., bandwidth) have been reserved for the service request. A-RACF 58 acknowledges receipt of this information from the CLF 10 via signal 70. According to this exemplary embodiment, CLF 10 then provides the CNGCF 32 with the afore-described information so that the CNGCF 32 can retrieve and forward an appropriate configuration data file to the UE 12/CNG 28. More specifically, according to this exemplary embodiment, CLF 10 provides the assigned IP address, terminal type and service subscription ID to the CNGCF 32 via signal 72 over interface 40. The CLF 10 may, for example, be connected to multiple CNGCFs 32. The address of each the CNGCFs 32 can be pre-provisioned in the CLF 10. Based, for example, on the IP address range or similar information associated with the UE 12, the CLF 10 can look up the address of the corresponding CNGCF 32 in order to forward this configuration data file selection information bundle.

Upon reception of signal 72 and its corresponding information from the CLF 10, CNGCF 32 can acknowledge receipt via signal 74 and select a corresponding terminal data configuration file using the service subscription ID and terminal type, e.g., as described above with respect to FIG. 3. The CNGCF 32 can then forward the selected terminal configuration data file to the UE 12/CNG 28 in, for example, one of two ways. According to one exemplary embodiment, the CNGCF 32 can forward the selected terminal configuration data file in response to the receipt of signal 72, i.e., CNGCF 32 pushes the configuration data file to the UE 12/CNG 28 as signal 76. Alternatively, according to another exemplary embodiment, the CNGCF 32 can instead notify the UE 12/CNG 28 via signal 76 that a configuration data file is available and await a request (not shown in FIG. 4) from the UE 12/CNG 28 to send that configuration data file to the CNG 28, i.e., the CNG 28 pulls the configuration data file from the CNGCF 32. Upon reception of the configuration data file, the CNG 28 will update its software accordingly, e.g., to configure its firewall, to handle QoS marking of IP packets, and/or to update bandwidth settings of the home gateway, etc. It will be appreciated that the configuration data file may, alternatively or additionally, include data associated with other types of CNG 28 reconfigurations.

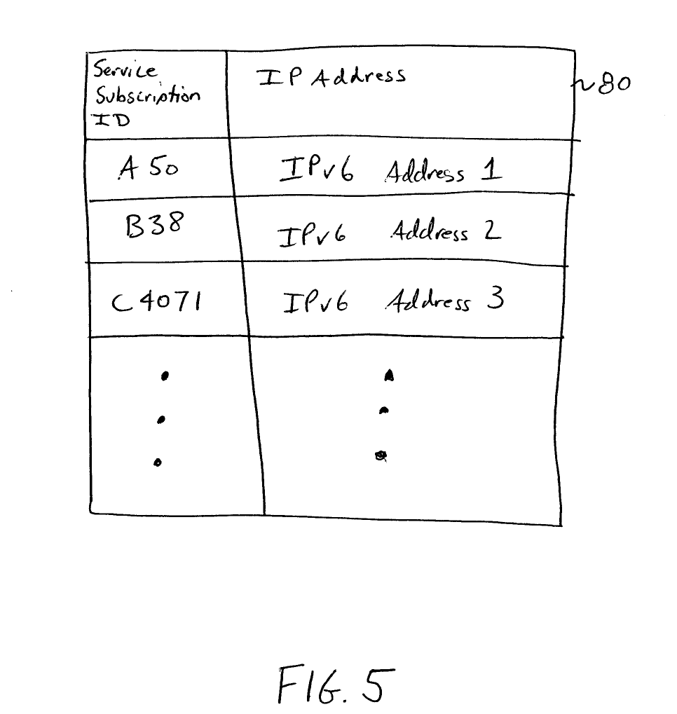

The subscriber may subscribe to new services at any time and such new service subscriptions may affect the configuration settings to be used by the associated CNG 28. For example, the subscriber could subscribe to a new service which provides for high definition video conferencing with an attendant increase in bandwidth utilization. Thus, the CNGCF 32 can also, optionally, store the IP address which has been assigned to the UE 12/CNG 28 to facilitate service-based configuration changes which occur after the network attachment process, e.g., pushing the new bandwidth settings to the CNG 28 using the stored IP address after the high definition video conferencing subscription is confirmed in the system. An example of IP addresses stored as a function of service subscription identifiers is shown, for example, in the table 80 of FIG. 5. This enables authorized entities which possess the service subscription ID to notify the CNGCF 32 of such changes in services, so that CNGCF 32 can retrieve the corresponding IP address from its memory and provide another configuration data file to the appropriate UE 12/CNG 28 as described above.

Structurally, the various entities discussed above, e.g., CLF 10 and CNGCF 32 can, for example, each be implemented in hardware and software as servers. For example, as shown generally in FIG. 6, such a server 600 can include a processor 602 (or multiple processor cores), memory 604, one or more secondary storage devices 606 (e.g., external storage device(s)), an operating system 608 running on the processor 604 and using the memory 604, as well as a corresponding application 610, e.g., a CLF application for the CLF server, and a CNGCF application for the CNGCF server. An interface unit 612 may be provided to facilitate communications between the node 600 and the rest of the network or may be integrated into the processor 602. Thus, according to one exemplary embodiment, a network node, e.g., a CNGCF 32, can include a processor 602 for receiving information associated with an address of a user equipment 12, a service subscription associated with the user equipment 12 and a terminal type associated with said user equipment 12, a memory 604 and/or 606 for storing configuration data files indexed by service subscription ID and terminal type wherein the processor 602 uses the received service subscription ID and terminal type to retrieve a corresponding configuration data file from the memory 604 and/or 606 and forward the configuration data file to the received address.

Similarly, according to another exemplary embodiment, a network node, e.g., a CLF 10, can include a processor 602 for receiving, during network attachment of a user equipment, a service subscriber ID, an address of the user equipment 12 associated with the service subscriber ID and a terminal type associated with the user equipment 12, wherein the processor 602 forwards the service subscription ID, the address and the terminal type toward a Customer Network Gateway Configuration Function (CNGCF).

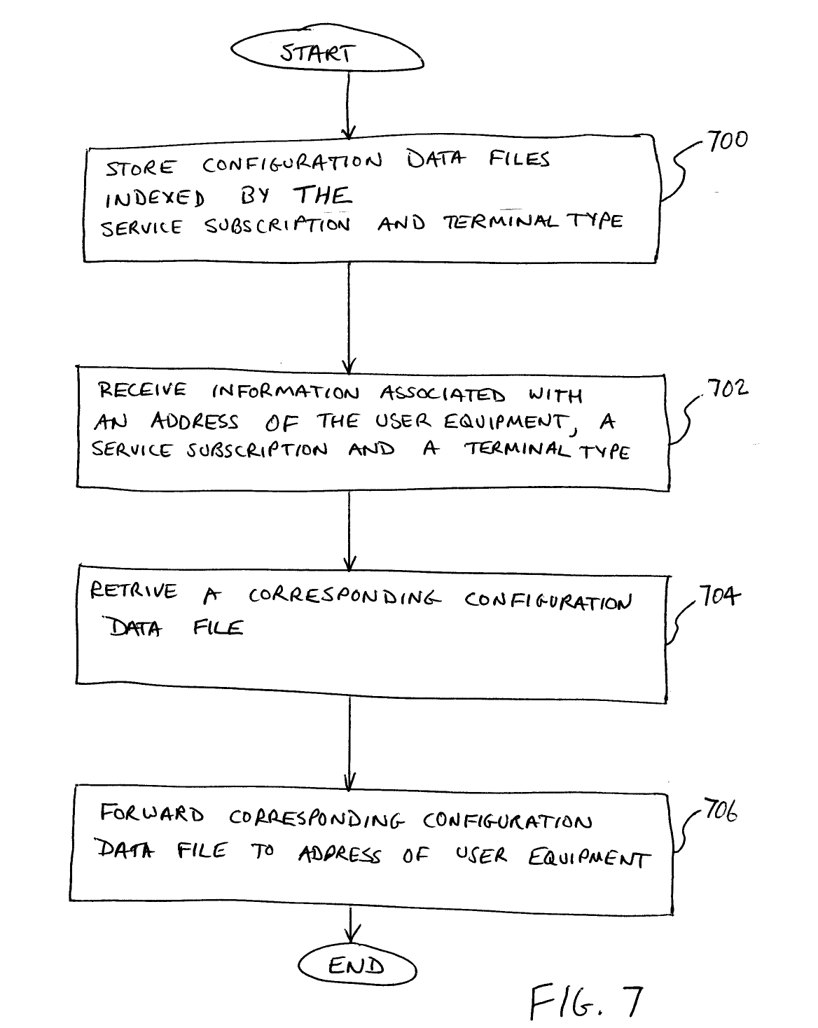

According to another exemplary embodiment, a method for providing configuration data associated with a user equipment to a configuration function, e.g., from a CNGCF 32, includes the steps illustrated in the flowchart of FIG. 7. Therein, at step 700, configuration data files indexed by the service subscription ID and terminal type are stored. Information associated with an address of the user equipment, a service subscription ID associated with the equipment and a terminal type associated with the user equipment is received at step 702. Based on the received service subscription ID and terminal type, a corresponding configuration data file is retrieved at step 704. The retrieved configuration data file is forwarded to the address of the user equipment at step 706.

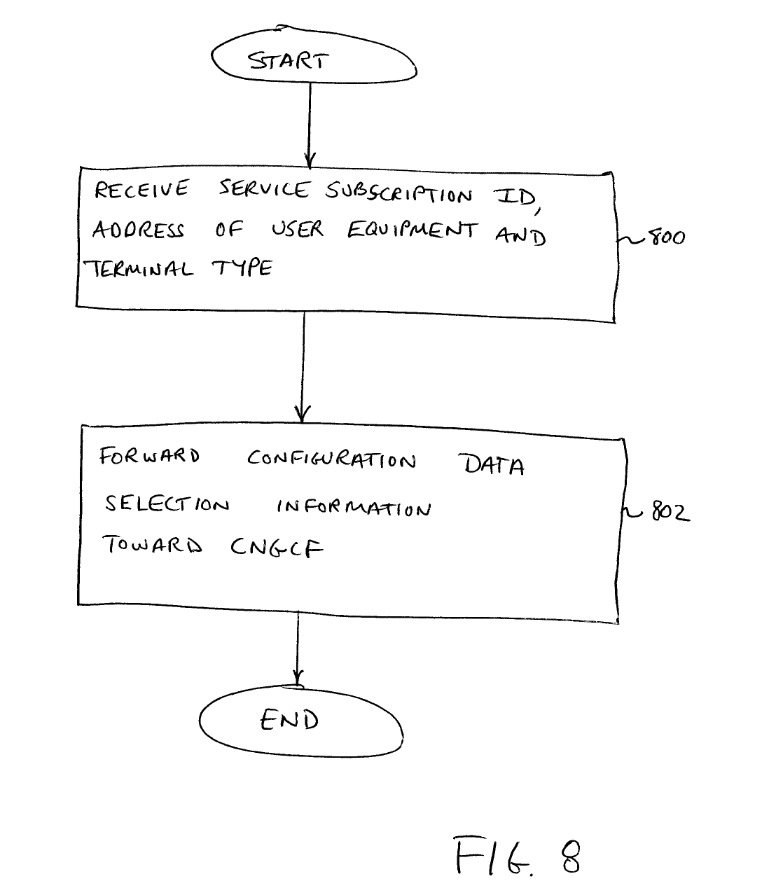

According to another exemplary embodiment, a method for providing configuration data selection information, e.g., from a CLF 10, to a configuration data file repository, e.g., a CNGCF 32, includes the steps illustrated in the flowchart of FIG. 8. A service subscription ID, an address of a user equipment associated with the service subscription ID, and a terminal type associated with the user equipment is received at step 800. The corresponding service subscriber identification, the address and the terminal type are then forwarded toward the appropriate CNGCF 32 as the configuration data selection information at step 802.

The foregoing description of exemplary embodiments provides illustration and description, but it is not intended to be exhaustive or to limit the invention to the precise form disclosed. For example, although the CNGCF 32 can be implemented independently of the CLF 10, e.g., as different servers, they can be co-located. Modifications and variations are possible in light of the above teachings or may be acquired from practice of the invention. The following claims and their equivalents define the scope of the invention.

1. A network node comprising:
a processor for receiving information associated with an address of a user equipment, a service subscription identifier associated with said user equipment and a terminal type associated with said user equipment; and
a memory for storing configuration data files indexed by service subscription identifier and terminal type;
wherein said processor uses said received service subscription identifier and said terminal type to retrieve a corresponding configuration data file from said memory and forwards said configuration data file to said address.

2. The network node of claim 1, wherein said network node operates as a Customer Network Gateway Configuration Function (CNGCF).

3. The network node of claim 1, wherein said address is an Internet Protocol (IP) address.

4. The network node of claim 1, wherein said configuration data file specifies at least one of: configuration of a firewall, quality of service (QoS) marking of IP packets and bandwidth setting of a home gateway.

5. The network node of claim 1, wherein said forwarding of said configuration data file to said address is responsive to receipt of said information.

6. The network node of claim 1, wherein said processor also transmits a notification message indicating that said configuration data file is available and, upon receiving a response to said notification message, forwards said configuration data file to said address.

7. The network node of claim 1, wherein said memory device also stores said address.

8. A method for providing configuration data associated with user equipment to a configuration function comprising:
storing configuration data files indexed by service subscription identifier and terminal type;
receiving information associated with an address of said user equipment, a service subscription identifier and a terminal type associated with said user equipment;
retrieving, based on said received service subscription identifier and terminal type, a corresponding configuration data file; and
forwarding said configuration data file to said address.

9. The method of claim 8, wherein said functions of storing, receiving, retrieving and forwarding are performed by a Customer Network Gateway Configuration Function (CNGFC).

10. The method of claim 8, wherein said address is an Internet Protocol (IP) address.

11. The method of claim 8, wherein said configuration data file specifies at least one of: configuration of a firewall, quality of service (QoS) marking of IP packets and bandwidth setting of a home gateway.

12. The method of claim 8, wherein said forwarding of said configuration data file to said address is responsive to receipt of said information.

13. The method of claim 8, further comprising:
transmitting a notification message indicating that said configuration data file is available and, upon receiving a response to said notification message, forwarding said configuration data file to said address.

14. A network node comprising:
a processor for receiving, during network attachment of a user equipment, a service subscription identifier, an address of said user equipment associated with said service subscription identifier and a terminal type associated with said user equipment; and
wherein said processor forwards said service subscription identifier, said address and said terminal type toward a Customer Network Gateway Configuration Function (CNGCF).

15. The network node of claim 14, wherein said network node operates as a Connectivity Session Location and Repository Function (CLF).

16. The network node of claim 14, wherein said address is an Internet Protocol (IP) address.

17. A method for providing configuration data selection information to a configuration data file repository comprising:
receiving a service subscription identification, an address of a user equipment associated with said service subscription identification, and a terminal type associated with said user equipment; and
forwarding said service subscription identification, said address and said terminal type as said configuration data selection information.

18. The method of claim 17, wherein said functions of storing, receiving, retrieving and forwarding are performed by a Connectivity Session Location and Repository Function (CLF).

19. The method of claim 17, wherein said address is an Internet Protocol (IP) address.

20. The network node of claim 1, wherein said service subscription identifier includes data associated which represents physical and virtual connection characteristics associated with a particular subscription.

21. The method of claim 8, wherein said service subscription identifier includes data associated which represents physical and virtual connection characteristics associated with a particular subscription.

22. The network node of claim 14, wherein said service subscription identifier includes data associated which represents physical and virtual connection characteristics associated with a particular subscription.

23. The method of claim 17, wherein said service subscription identification includes data associated which represents physical and virtual connection characteristics associated with a particular subscription.
